(19) United States
(12) Patent Application Publication
(10) Pub. No.: US 2013/0199711 A1
(43) Pub. Date: Aug. 8, 2013

(54) MOLD ASSEMBLY FOR MIDSOLE AND METHOD OF MANUFACTURING SAME

(71) Applicant: NIKE, INC., Beaverton, OR (US)

(72) Inventors: Carrie Davis, Portland, OR (US); Paul VanDOMELEN, Busan (KR); David P. Jones, Beaverton (CA); William Flannery, Beaverton, OR (US)

(73) Assignee: NIKE, INC., Beaverton, OR (US)

(21) Appl. No.: 13/836,836

(22) Filed: Mar. 15, 2013

Related U.S. Application Data
(63) Continuation-in-part of application No. 12/252,666, filed on Oct. 16, 2008.

(51) Int. Cl. B29D 35/00

(52) U.S. Cl. CPC B29D 35/00
USPC 156/245

(57) ABSTRACT

A mold assembly includes an upper portion having an upper recess in a lower surface thereof; an insert having an upper surface configured to mate with the upper portion's lower surface; a first channel in one of the upper portion and the insert and in fluid communication with an exterior of the one of the upper portion and the insert and with the upper recess when the upper portion and the insert are in contact with one another. A lower portion has a lower recess in an upper surface thereof, the upper surface configured to mate with the insert's lower surface. A second channel in one of the lower portion and the insert, the second channel is in fluid communication with an exterior of the one of the lower portion and the insert and the lower recess when the lower portion and the insert are in contact with one another.

### RELATED APPLICATIONS

This application is a continuation-in-part application of application Ser. No. 12/252,666, filed on Oct. 16, 2008, which is incorporated herein by reference in its entirety.

### FIELD OF THE INVENTION

Aspects of this invention relate generally to a mold assembly for a midsole and a method of manufacture, and, in particular, to a mold assembly for producing a midsole including portions having different characteristics such as densities.

### BACKGROUND OF THE INVENTION

Conventional articles of athletic footwear include two primary elements, an upper and a sole structure. The upper provides a covering for the foot that comfortably receives and securely positions the foot with respect to the sole structure. In addition, the upper may have a configuration that protects the foot and provides ventilation, thereby cooling the foot and removing perspiration. The sole structure is secured to a lower portion of the upper and is generally positioned between the foot and the ground. In addition to attenuating ground reaction forces, the sole structure may provide fraction, control foot motions (e.g., by resisting over pronation), and impart stability, for example. Accordingly, the upper and the sole structure operate cooperatively to provide a comfortable structure that is suited for a wide variety of activities, such as walking and running.

The sole structure generally incorporates multiple layers that are conventionally referred to as an insole, a midsole, and an outsole. The insole is a thin, compressible member located within the upper and adjacent to a plantar (i.e., lower) surface of the foot to enhance footwear comfort. The midsole, which is conventionally secured to the upper along the length of the upper, forms a middle layer of the sole structure and is primarily responsible for attenuating ground reaction forces. The outsole forms the ground-contacting element of footwear and is usually fashioned from a durable, wear-resistant material that includes texturing to improve traction.

The conventional midsole is primarily formed from a resilient, polymer foam material, such as polyurethane or ethylvinylacetate, that extends throughout the length of the footwear, often by way of an injection molding process. The properties of the polymer foam material in the midsole are primarily dependent upon factors that include the dimensional configuration of the midsole and the specific characteristics of the material selected for the polymer foam, including the density of the polymer foam material. By varying these factors throughout the midsole, the relative stiffness and degree of ground reaction force attenuation may be altered to meet the specific demands of the activity for which the footwear is intended to be used. In addition to polymer foam materials, conventional midsoles may include, for example, one or more fluid-filled bladders and moderators.

It would be desirable to provide a mold assembly for a midsole having portions with different characteristics and a method of manufacturing a midsole having portions with different characteristics that reduces or overcomes some or all of the difficulties inherent in prior known devices. Particular objects and advantages will be apparent to those skilled in the art, that is, those who are knowledgeable or experienced in this field of technology, in view of the following disclosure of the invention and detailed description of certain embodiments.

### SUMMARY

The principles of the invention may be used to advantage to provide a mold assembly that can be used to form a midsole having a portion with a first characteristic, such as a density, and another portion with a second characteristic, such as a density, that is different than the first. In accordance with a first aspect, a mold assembly includes an upper portion having an upper recess in a lower surface thereof; an insert having an upper surface configured to mate with the upper portion's lower surface; a first channel in one of the upper portion and the insert and in fluid communication with an exterior of the one of the upper portion and the insert and with the upper recess when the upper portion and the insert are in contact with one another. A lower portion has a lower recess in an upper surface thereof, the upper surface configured to mate with the insert's lower surface. A second channel in one of the lower portion and the insert, the second channel is in fluid communication with an exterior of the one of the lower portion and the insert and the lower recess when the lower portion and the insert are in contact with one another

In accordance with another aspect, a mold assembly for a midsole includes an upper portion having a plurality of upper recesses formed in a lower surface thereof. An insert has an upper surface configured to mate with the lower surface of the upper portion. A first channel is formed in one of the upper portion and the insert, the first channel being in fluid communication with an exterior of the one of the upper portion and the insert and in fluid communication with each upper recess when the upper portion and the insert are in contact with one another. A lower portion has a plurality of lower recesses formed in an upper surface thereof, the upper surface being configured to mate with a lower surface of the insert. A second channel is formed in one of the lower portion and the insert, with the second channel being in fluid communication with an exterior of the one of the lower portion and the insert and in fluid communication with each lower recess when the lower portion and the insert are in contact with one another.

In accordance with a further aspect, a method of forming midsole with a mold assembly including an upper portion having an upper recess formed in a lower surface thereof; an insert having an upper surface configured to mate with the lower surface of the upper portion; a first channel formed in one of the upper portion and the insert, the first channel being in fluid communication with an exterior of the one of the upper portion and the insert, and in fluid communication with the upper recess when the upper portion and the insert are in contact with one another; a lower portion having a lower recess formed in an upper surface thereof, the upper surface configured to mate with a lower surface of the insert; a second channel formed in one of the lower portion and the insert, the second channel being in fluid communication with an exterior of the one of the lower portion and the insert, and in fluid communication with the lower recess when the lower portion and the insert are in contact with one another, includes the following steps: placing the lower surface of the upper portion in contact with the upper surface of the insert, and the lower surface of the insert in contact with the upper surface of the lower portion; injecting a first material through the first channel into the upper recess; injecting a second material through the second channel into the lower recess; separating the upper portion, the insert and the lower portion from one another; placing the lower surface of the upper portion in contact with the upper surface of the lower portion; and curing the first material in the upper recess and the second material in the lower recess so the first material and second material bond to form a midsole

Substantial advantage is achieved by providing a mold assembly for a midsole having portions with different characteristics and a method of manufacturing such a midsole. In particular, certain embodiments provide a mold assembly and method that allows production of a midsole having portions with different densities or different hardnesses.

These and additional features and advantages disclosed here will be further understood from the following detailed disclosure of certain embodiments.

### BRIEF DESCRIPTION OF THE DRAWINGS

FIG. 1 is a section view of an illustrative aspect of a mold assembly having an upper portion, a lower portion, and an insert positioned between the upper and lower portions.

FIG. 2 is a section view of the mold assembly of FIG. 1, shown with a first material injected into the upper portion and a second material injected into the lower portion.

FIG. 3 is a section view of the mold assembly of FIG. 1, shown with the insert removed and the upper and lower portions adjacent one another.

FIG. 4 is an elevation view of a midsole formed in the mold assembly of FIG. 1.

FIG. 5 is another illustrative aspect of a mold assembly having an upper portion, a central portion an insert positioned between the upper and central portions, and a lower portion.

FIG. 6 is an elevation view of a midsole formed in the mold assembly of FIG. 5.

FIG. 7 is a section view of the lower portion of FIG. 1, showing surface irregularities formed in a lower recess in the lower portion.

FIG. 8 is another illustrative aspect of a mold assembly showing a plurality of recesses in the upper and lower portions.

FIG. 9 is another illustrative aspect of a mold assembly showing a lower recess in a lower portion of the mold assembly that extends along only a portion of an upper recess in an upper portion of the mold assembly.

FIG. 10 is another illustrative aspect of a mold assembly showing an upper recess in an upper portion of the mold assembly that extends along only a portion of a lower recess in a lower portion of the mold assembly.

FIG. 11 is a section view of a secondary mold assembly for processing first and second midsole portions of a midsole preform.

FIG. 12 is an exploded perspective view of an alternative embodiment of first and second midsole portions of a midsole preform.

FIG. 13 is a section view of the lower portion of the secondary mold assembly of FIG. 11.

The figures referred to above are not drawn necessarily to scale, should be understood to provide a representation of particular embodiments of the invention, and are merely conceptual in nature and illustrative of the principles involved. Some features of the mold assembly for a midsole depicted in the drawings have been enlarged or distorted relative to others to facilitate explanation and understanding. The same reference numbers are used in the drawings for similar or identical components and features shown in various alternative embodiments. Mold assemblies for a midsole and methods of manufacture for such a midsole as disclosed herein would have configurations and components determined, in part, by the intended application and environment in which they are used.

### DETAILED DESCRIPTION OF CERTAIN PREFERRED EMBODIMENTS

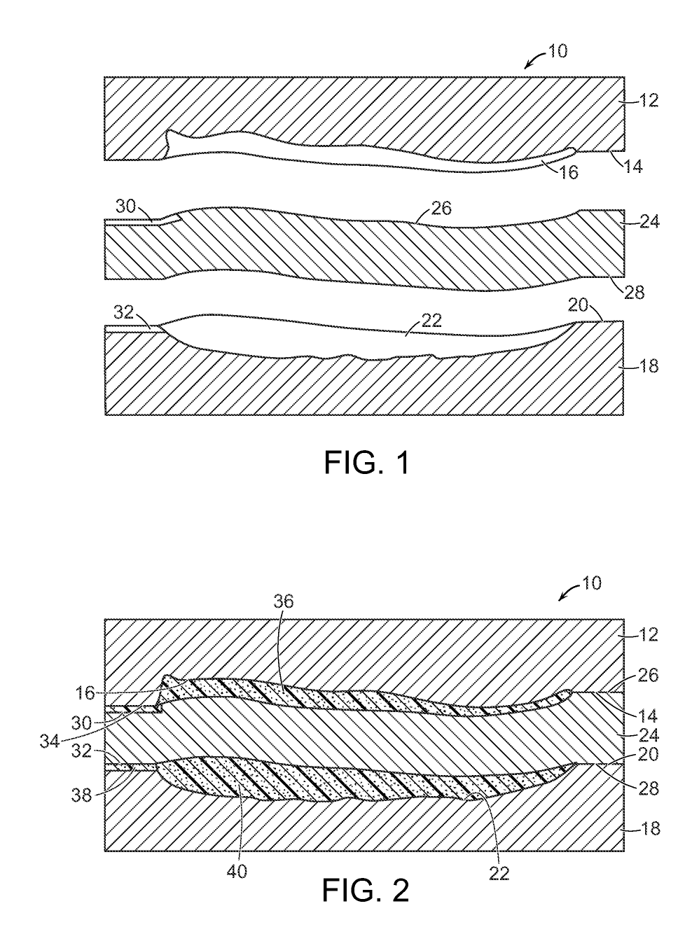

An illustrative embodiment of a mold assembly 10 for use in forming a midsole for an article of footwear is shown in FIG. 1. Mold assembly 10 includes an upper portion 12 having a lower surface 14 with an upper recess 16 formed in lower surface 14. As discussed in greater detail below, an upper portion of a midsole will be formed in upper recess 16.

A lower portion 18 of mold assembly 10 has an upper surface 20 with a lower recess 22 formed in upper surface 20. As discussed in greater detail below, a lower portion of a midsole will be formed in lower recess 22.

An insert 24 is positioned between upper portion 12 and lower portion 18. An upper surface 26 of insert 24 is shaped or configured to mate with lower surface 14 of upper portion 12. Similarly, a lower surface 28 of insert 24 is shaped or configured to mate with upper surface 20 of lower portion 18.

A first channel 30 is formed in insert 24 and extends from an exterior of insert 24 to upper surface 26 of insert 24. Thus, first channel 30 is in fluid communication with the exterior of insert 24 and upper recess 16 when insert 24 and upper portion 12 are in contact with one another.

It is to be appreciated that in certain embodiments, first channel 30 could be formed in upper portion 12, in which case first channel 30 would be in fluid communication with the exterior of upper portion 12 and upper recess 16. In other embodiments, a portion of first channel 30 could be formed in upper portion 12 and a mating portion of first channel 30 could be formed in insert 24. In each of these embodiments, first channel 30 is configured to allow material to be introduced from an exterior of the mold into upper recess 16.

A second channel 32 is formed in lower portion 18 and extends from an exterior of lower portion 18 to lower recess 22. Thus, second channel 32 is in fluid communication with the exterior of lower portion 18 and lower recess 22 when insert 24 and lower portion 18 are in contact with one another.

It is to be appreciated that in certain embodiments, second channel 32 could be formed in insert 24, in which case second channel 32 would be in fluid communication with the exterior of insert 24 and lower recess 22. In other embodiments, a portion of second channel 32 could be formed in lower portion 18 and a mating portion of second channel 32 could be formed in insert 24. In each of these embodiments, second channel 32 is configured to allow material to be introduced from an exterior of mold assembly 10 into lower recess 22.

Thus, it is to be appreciated that insert 24 could have a single channel formed therein, as illustrated here, or insert 24 could have both of first and second channels 30, 32 formed therein. In other embodiments, insert 24 could have no channels and first and second channels 30, 32 could be formed in upper portion 12 and lower portion 18, respectively.

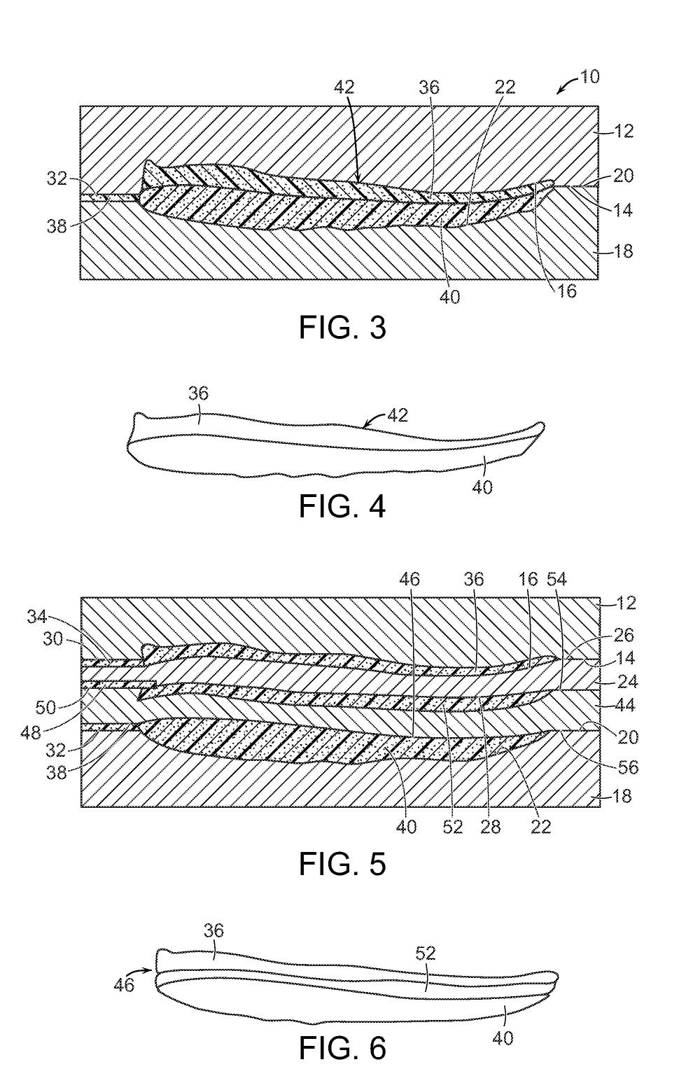

A method of forming a midsole using mold assembly 10 is illustrated in FIGS. 2-3. Upper portion 12 and insert 24 are placed into contact with one another such that lower surface 14 of upper portion 12 mates with and abuts upper surface 26 of insert 24. Similarly, lower portion 18 and insert 24 are placed into contact with one another such that lower surface 28 of insert 24 mates with and abuts upper surface 20 of lower portion 18.

A first material 34 is injected through first channel 30 into upper recess 16, thereby forming a midsole upper portion 36. Similarly, a second material 38 is injected through second channel 32 into lower recess 22, thereby forming a midsole lower portion 40.

Upper portion 12, insert 24, and lower portion 18 are then separated, insert 24 is removed, and lower surface 14 of upper portion 12 and upper surface 20 of lower portion 18 are then placed into contact with one another, as seen in FIG. 3. At this point, midsole upper portion 36 and midsole lower portion 40 are in contact with one another within mold assembly 10, thereby forming a midsole 42, seen in its entirety in FIG. 4. Midsole 42 remains in mold assembly 10 under heat and pressure for a desired amount of time to allow midsole upper portion 36 and midsole lower portion 40 to bond to one another. In certain embodiments, midsole 42 remains in mold assembly 10 for approximately 8 minutes at a temperature of approximately 170-180° C. and a pressure of approximately 100-120 kg/cm².

Once midsole 42 is removed from mold assembly 10 it undergoes typical post cure processing steps including, for example, buffing, washing, and trimming.

In certain embodiments, first material 34 and second material 38 may have a characteristic, with the value of the characteristic of each of first and second material 34 being different than the other. Thus, in certain embodiments, second first material 34 may have a first density and second material 38 may have a second density that is different than the first density. In certain embodiments, for example, first material 34 has a first density with a specific gravity between approximately 0.15 and approximately 0.25. In certain embodiments, second material 38 has a second density with a specific gravity between approximately 0.25 and approximately 0.35.

In certain embodiments, first material 34 may have a first hardness and second material 38 may have a second hardness that is different than the first hardness. In certain embodiments, first material 34 has a first hardness between approximately 40 and approximately 45 Asker C. In certain embodiments, second material 38 has a second hardness between approximately 60 and approximately 65 Asker C.

By providing first material 34 with a different density or hardness than second material 38, midsole 42 can be modified to achieve particular performance characteristics. In certain embodiments, for example, first material 34 is less dense than second material 38 such that midsole upper portion 36 is softer than that of midsole lower portion 40 of midsole 42, thereby providing comfort for the user while at the same time providing adequate support.

First and second materials 34, 38 can be formed of any desired material. Suitable first and second materials in clued an include rubber, polyurethane foam, microcellular elastomeric foams, or phylon (Ethylene Vinyl Acetate (‘EVA’) foam). Other suitable first and second materials will become readily apparent to those skilled in the art, given the benefit of this disclosure.

Another embodiment is shown in FIG. 5 in which mold assembly 10 includes a central portion 44. Central portion 44 includes a central recess 46. A third material 48 is injected into central recess 46 through a third channel 50 to form a midsole central portion 52 of a midsole 46, seen in FIG. 6. In the illustrated embodiment, central portion 44 is positioned between insert 24 and lower portion 18 so that an upper surface 54 of central portion 44 mates with lower surface 28 of insert 24, and a lower surface 56 of central portion 44 mates with upper surface 20 of lower portion 18. It is to be appreciated that in certain embodiments central portion 44 could be positioned between upper portion 12 and insert 24, in which case upper surface 54 of central portion 44 would mate with lower surface 14 of upper portion 12, and lower surface 56 of central portion 44 would mate with upper surface 26 of insert 24.

In the illustrated embodiment, third channel 50 is formed in insert 24 and extends from an exterior of insert 24 to lower surface 28 of insert 24. Thus, third channel 50 is in fluid communication with the exterior of insert 24 and central recess 46 when insert 24 and central portion 44 are in contact with one another.

In the illustrated embodiment, first channel 30 is formed in upper portion 12, although it is to be appreciated that first channel 30 can be formed in insert 24 in this embodiment as well. Similarly, second channel 32 is formed in lower portion 18, although it is to be appreciated that second channel 32 can be formed in central portion 44 in this embodiment as well.

It is to be appreciated that in certain embodiments, third channel 50 could be formed in central portion 44, in which case third channel 50 would be in fluid communication with the exterior of central portion 44 and central recess 46. In either embodiment, third channel 50 is configured to allow a third material to be introduced from an exterior of mold assembly 10 into central recess 46.

In such an embodiment, third material 48 could have a third density or third hardness that is different than at least one of the first and second densities or first and second hardnesses. In certain embodiments, third material 48 has a third density that is different from both of the first and second densities. In certain embodiments, third material 48 has a third hardness that is different from both of the first and second hardnesses.

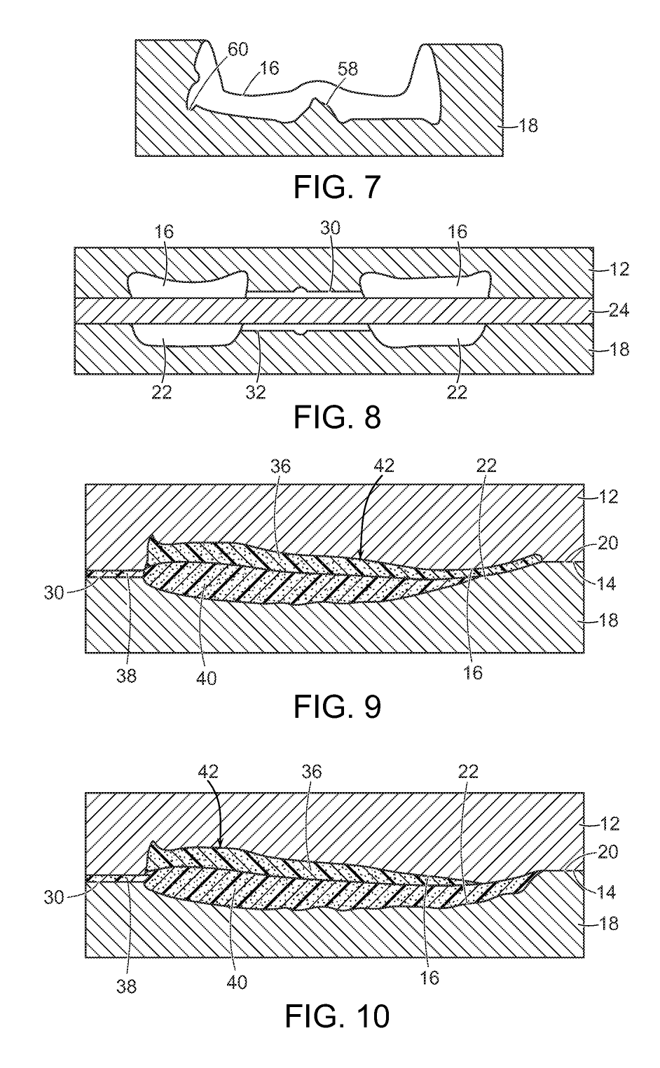

In certain embodiments, mold assembly 10 may include one or more surface irregularities that produce corresponding surface irregularities in midsole 42. As illustrated in FIG. 7, lower recess 16 is shown with at least one projection 58 that forms a corresponding recess in midsole lower portion 40. Additionally, lower recess 16 is seen here with at least one groove or recess 60 that forms a corresponding ridge or projection on midsole lower portion 40. It is to be appreciated that any portion of mold assembly 10 may include any number of surface irregularities, having any desired shape, that are configured to produce mating surface irregularities in midsole 42. Thus the surface of midsole 42 can easily be modified for performance or aesthetic benefits through the use of surface irregularities in mold assembly 10.

Another embodiment is seen in FIG. 8, in which mold assembly 10 is used to produce more than one midsole 42 during a molding process. As illustrated here, upper portion 12 includes two upper recesses 16, each of which is in fluid communication with first channel 30. Similarly, lower portion 18 includes two lower recesses 22, each of which is in fluid communication with second channel 32. It is to be appreciated that more than two midsoles 42 can be produced with a single mold assembly 10.

Another embodiment is illustrated in FIG. 9, in which lower recess 22 extends along only a portion of upper recess 16 such that when midsole 42 is formed it has two layers for only a portion of its length, with midsole lower portion 40 extending along only a portion of the length of midsole upper portion 36. In the illustrated embodiment, lower recess 22 extends from the heel portion of upper recess 16 to a metatarsal region of upper recess 16. It is to be appreciated that lower recess 22 can extend along any desired portion of upper recess 16.

In another embodiment, as illustrated in FIG. 10, upper recess 16 extends along only a portion of lower recess 22 such that when midsole 42 is formed it has two layers for only a portion of its length, with midsole upper portion 36 extending along only a portion of the length of midsole lower portion 40. In the illustrated embodiment, upper recess 16 extends from the heel portion of lower recess 22 to a metatarsal region of lower recess 22. It is to be appreciated that upper recess 16 can extend along any desired portion of lower recess 22.

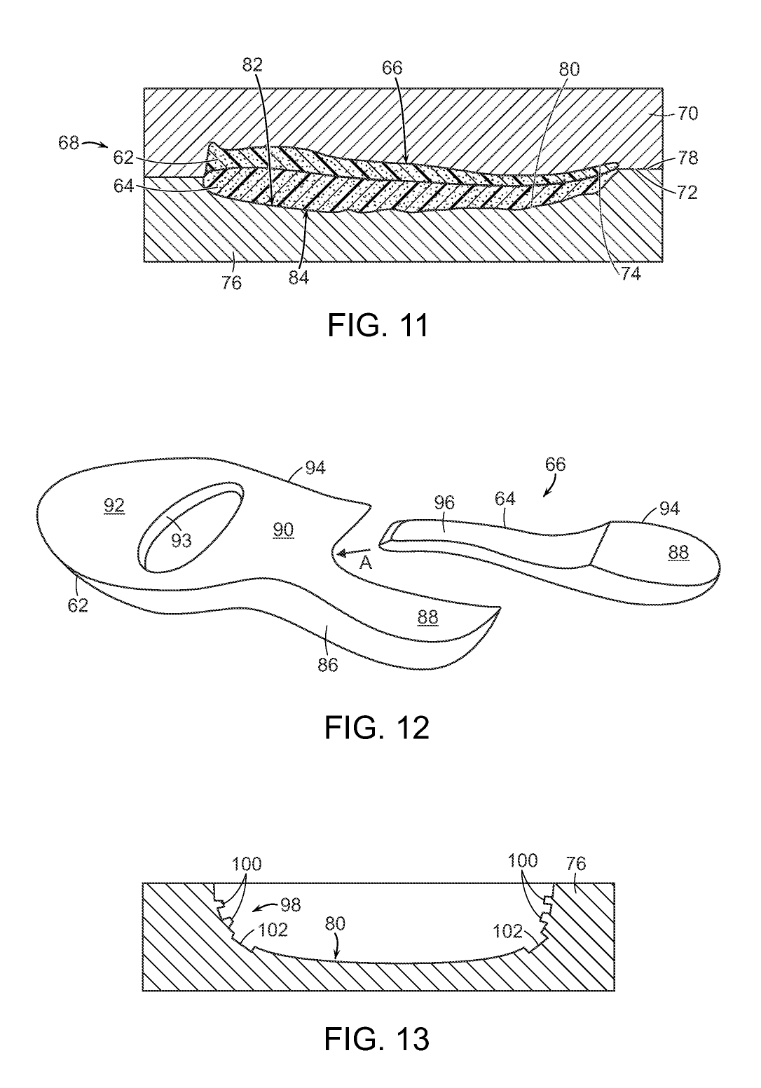

In certain embodiments, a midsole formed in mold assembly 10 can be considered a preform of a midsole, subject to further molding and processing steps. In such an embodiment, a first midsole portion 62 and a second midsole portion 64 (seen below in FIG. 11) of injection phylon, for example, are separately formed in mold assembly 10 in what is known as a cold injection process. That is, no additional external heat is applied to the mold so that the materials do not expand. When first midsole portion 62 and second midsole portion 40 are subsequently positioned adjacent one another in mold assembly 10 and heat and pressure are applied, they expand and bond together, free of any adhesive, forming a midsole preform 66. The midsole preform 66 is then removed from mold assembly 10, which can be considered a primary mold assembly, and is then processed in a secondary mold assembly 68, as seen in FIG. 11.

Secondary mold assembly 68 includes an upper portion 70 having a lower surface 72. An upper recess 74 is formed in lower surface 72. A lower portion 76 of secondary mold assembly 68 has an upper surface 78. A lower recess 80 is formed in upper surface 78. Upper recess 74 and lower recess 80 cooperate to define a midsole recess 82 in secondary mold assembly 68. Midsole recess 82 is sized to be smaller than the size of midsole preform 66. In certain embodiments, midsole recess 82 has a size that is between approximately 20% and 30% smaller than the size of midsole preform 66.

Midsole preform 66 is then positioned within midsole recess 82. In certain embodiments, second midsole portion 64 of midsole preform 66 is first positioned in lower recess 80 of lower portion 76. Since the size of lower recess 80 is less than that of second midsole portion 64, second midsole portion 64 must be compressed and squeezed into lower recess 80. Upper portion 70 of secondary mold assembly 68 is then positioned in abutment with lower portion 76, while compressing and squeezing second midsole portion 62 of midsole preform 66 into upper recess 74, so that secondary mold assembly 68 is in a closed condition.

Midsole preform 66 in secondary mold assembly 68 is then subjected to heat and pressure, thereby being transformed into a midsole 84. In certain embodiments, midsole preform 66 remains in secondary mold assembly 68 for approximately 8 minutes at a temperature of approximately 170-180° C. and a pressure of approximately 100-120 kg/cm² to form midsole 84. Once midsole 84 is removed from secondary mold assembly 68, it may undergo post cure processing steps including, for example, buffing, washing, and trimming.

In this illustrated embodiment, first midsole portion 62 and second midsole portion 64 form upper and lower portions, respectively, of midsole preform 66. It is to be appreciated that first midsole portion 62 and second midsole portion 64 could form different portions of midsole preform 66. For example, in the embodiment illustrated in FIG. 12, first midsole portion 62 forms a medial side 86 of a heel portion 88 of midsole preform 66, and forms the majority of midfoot portion 90 and forefoot portion 92 of midsole preform 66. Second midsole portion 64 forms a lateral side 94 of heel portion 88 of midsole preform 66. A front portion 96 of second midsole portion 64 extends beneath lateral side 94 of midfoot portion 90 and forefoot portion 92 of first midsole portion 62, as illustrated by the arrow A. It is to be appreciated that first midsole portion 62 and second midsole portion 64 can take any desired shape and form any respective portions of midsole preform 66.

In such an embodiment, insert 24 would not necessarily be required to form first midsole portion 61 and second midsole portion 63 in mold assembly 10. Rather, they can be formed in standard fashion separately from one another, either in the same mold or in separate molds.

In certain embodiments, as illustrated in FIG. 12, forefoot portion 92 of first midsole portion 62 may include a recess 93 in its upper surface. Recess 93 is configured to receive a fluid-filled bladder, which may be filled with air or other gasses.

In such an embodiment, the final shape, size, and external surface characteristics of midsole 84 are determined while it is being formed in secondary mold assembly 68. To form the particular surface characteristics, or surface irregularities, of midsole 84, the surface of midsole recess 82 includes surface irregularities which in turn cause mating surface irregularities to be formed on midsole 84. As seen in the embodiment illustrated in FIG. 12, lower recess 80 of lower portion 76 includes surface irregularities 98.

When midsole preform 66 is squeezed into lower recess 80 and subjected to heat and pressure, its exterior surface conforms to the interior surface of lower recess 80. Thus, the exterior surface of midsole 84 will have a mirror image of the surface of lower recess 80. In the illustrated embodiment, surface irregularities 98 include projections 100 and recesses 102. Projections 100 will form corresponding recesses in the exterior surface of midsole 84, while recesses 102 will form corresponding projections on the exterior surface of midsole 84. It is to be appreciated that surface irregularities 98 can include any number of projections 100 and/or recesses 102. Further, it is to be appreciated that surface irregularities 98 can take any desired shape, and that the corresponding shapes formed on the surface of midsole 84 will be a mating mirror image of those surface irregularities. Other suitable shapes for the surface irregularities 98 to produce corresponding surface irregularities on the surface of midsole 84 will become readily apparent to those skilled in the art, given the benefit of this disclosure.

Thus, while there have been shown, described, and pointed out fundamental novel features of various embodiments, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is the intention, therefore, to be limited only as indicated by the scope of the claims appended hereto.

What is claimed is:

1. A method of forming a midsole comprising;
injection molding a first midsole portion of a midsole preform and a second midsole portion of the midsole preform;
subjecting the first midsole portion and the second midsole portion to heat and pressure such that the first midsole portion and the second midsole portion bond to one another and expand, forming the midsole preform;
positioning the midsole preform in a midsole recess of a secondary mold assembly, the midsole recess having a size smaller than a size of the midsole preform;
subjecting the midsole preform to heat and pressure in the secondary mold assembly to form a midsole; and
removing the midsole from the secondary mold assembly.

2. The method of claim 1, wherein a surface of the midsole recess of the secondary mold assembly includes a surface irregularity.

3. The method of claim 2, wherein the surface irregularity is a projection.

4. The method of claim 2, wherein the surface irregularity is a recess.

5. The method of claim 1, wherein the first mold portion forms a medial side of a heel portion of the midsole preform and the majority of a midfoot portion and a forefoot portion of the midsole preform.

6. The method of claim 5, wherein the second midsole portion forms a lateral side of the heel portion of the midsole preform, and a front portion of the second midsole portion extends beneath a lateral side of the first midsole portion.

7. The method of claim 1, wherein size of the midsole recess is between approximately 20% and approximately 30% smaller than the size of the midsole preform.
